(19) United States
(12) Patent Application Publication
(10) Pub. No.: US 2014/0244332 A1
(43) Pub. Date: Aug. 28, 2014

(54) APPARATUS, METHOD AND SOFTWARE PRODUCTS FOR AUTOMATIC APPOINTMENT MATCHING

(71) Applicant: Yakov Z. Mermelstein, Spring Valley, NY (US)

(72) Inventor: Yakov Z. Mermelstein, Spring Valley, NY (US)

(21) Appl. No.: 13/780,809

(22) Filed: Feb. 28, 2013

(51) Int. Cl. G06Q 10/10

(52) U.S. Cl. CPC G06Q 10/1093
USPC 705/7.16

(57) ABSTRACT

The present invention provides systems, software and methods for automatic event matching, the method including receiving time, location and duration data of planned events from a plurality of individual users and to store the data in a database, dynamically adjusting the data associated with each user to define individual dynamic user-data based profile rankings; minimizing total duration data responsive to the profile rankings and outputting future individualized events schedules responsive to the minimizing step.

### FIELD OF THE INVENTION

The present invention relates generally to apparatus and methods for coordinating meetings, and, more specifically, to apparatus and methods for real-time automatic meeting coordination.

### BACKGROUND OF THE INVENTION

Many users of smart cellphones and networked computers have access to electronic calendars. However, it still remains difficult to coordinate a plurality of meetings in different locations and times.

Johnson (U.S. Pat. No. 5,664,063) describes a method of automatically informing a calendar user of certain meeting attributes when a meeting notice is posted to a calendar program. The user posts the meeting notice on the user's calendar. The posting routine of the calendar program reads the meeting notice and compares it with the user's posting profile which contains a plurality of search predicates. A search predicate includes one or more attributes of a calendar event notice, conjunctive specifications for the attributes, and specified criteria for each of the attributes. If certain attributes of the meeting notice match any number of the search predicates of the posting profile, the user's individual computer outputs an audio message associated with each search predicate found in the notice.

Hullot (US Published Patent Application 2004/0044646) discloses methods, systems and machine readable media for operating a calendar in a data processing system. In one exemplary method of managing a calendar, which contains at least one event, said method comprises: making available the calendar in an electronic format; subscribing to said calendar; downloading said calendar from a host electronic device to a subscriber electronic device; and storing said calendar in said electronic format to form a local calendar.

Wilbrink (US Published Patent Application) 2005/0091095 describes a method, system, and storage medium for performing calendaring and reminder activities for a computer user. The method includes analyzing text displayed on a computer screen, identifying calendar parameters resulting from the analysis, creating a calendar entry record that includes a source of the calendar parameters, pasting the calendar parameters into the calendar entry record, and automatically storing the calendar entry record in a calendar application without opening the calendar application. Calendar parameters include at least one of a date, a time, a meeting type, and a subject.

Chen (US Published Patent Application 2009/0094088) provides methods, systems, apparatuses, and computer program products for confirming attendance of prospective attendees to a meeting or events via time management or event scheduling applications, such as calendar applications, are disclosed. Various embodiments comprise scheduling the meeting, waiting for a period of time, and automatically sending confirmation requests to one or more prospective attendees of the meeting. Some embodiments also comprise sending invitations to and receiving acceptances by one or more prospective attendees. Some embodiments further comprise receiving one or more responses to the confirmation requests from the prospective attendees. Some embodiments may reschedule the meeting, or events of the meeting, based upon responses to the confirmation requests. Various embodiments may send or receive the confirmation requests and responses via instant messaging (IM) messages, e-mail messages, and short message service (SMS) messages. He does not disclose having the system automatically check the invitees' schedules to determine their availability based on both time and location and the meetings are arranged with some level of participation by the attendees, as opposed to automatically.

Guiheneuf (US Published Patent Application 2011/0295641) describes a method of sharing a calendar between a plurality of users, the calendar being capable of holding one or more events. The method comprises providing the calendar to each of said plurality of users; allowing any of said plurality of users to add to the calendar any of a new event, a change to an event and a message relating to an event; and providing any new event, change to an event or message added by a user to the other users. A change to an event may comprise a change to at least one of a start time of the event, an end time of the event, a description of the event, a status of the event, whether the event is to be repeated and the persons attending the event. At least one of an identification of a user who made a change, a time at which a change was made, a description of a change, a user comment relating to a change and an identification of the event before the change may be displayed for a selected event. He does not disclose having the system automatically check the invitees' schedules to determine their availability based on both time and location and the meetings are arranged with some level of participation by the attendees.

Cragan (U.S. Pat. No. 7,283,970) discloses a method and meeting scheduler are provided for automated meeting insertion and rescheduling for busy calendars. An electronic calendar meeting scheduling program stores meeting automation properties defined for each scheduled meeting. The electronic calendar meeting scheduling program stores meeting attendee automation properties defined for each attendee of each scheduled meeting. The electronic calendar meeting scheduling program utilizes the stored meeting automation properties and the stored meeting attendee automation properties to calculate a conflict score and action list for each potential time block for automated meeting insertion and rescheduling. The calculated conflict score and action list for each potential time block for rescheduling a meeting are based upon multiple factors including a move score, a leave early score, and a shorten meeting score. The action list includes an entry for each meeting altered for automated meeting insertion and rescheduling. He does not disclose having the system automatically check the invitees' schedules to determine their availability based on both time and location.

Thus, there still remains a need to provide user-personalized and dynamically updated automated meetings organization. In particular, prior art calendar programs are based on time. None take into consideration the location of the meeting. Therefore, there remains a need to provide an automated meetings/calendar routine that takes in account not only the time slot of the attendees but also the physical location of the meeting.

### SUMMARY OF THE INVENTION

These and other objects of the invention are achieved with a calendar system that automatically sets meetings based not only the time slot of the attendees but also the physical location of the meeting. By taking location into consideration, as well as time, the calendar system can more accurately determine if attendees are available. For example, if someone has an open time slot, the prior art systems will show him as available for the meeting and not take into account that he is 200 kilometers away! According to the herein calendar system, location is also considered. In this manner, if someone's time slot is open, but he is geographically too far away to attend, instead of getting a “false” availability, like in the prior art, the herein calendar system will note that he is not available.

There is thus provided according to an embodiment of the present invention, a method for automatic event matching, the method including; receiving time, location and duration data of planned events from a plurality of individual users and to store the data in a database; dynamically adjusting the data associated with each user to define individual dynamic user-data based profile rankings; minimizing total duration data responsive to the profile rankings; and outputting future individualized events schedules responsive to the minimizing step

Additionally, according to an embodiment of the present invention, the duration data includes, event duration, travel to event duration, travel from event duration, waiting time duration, communications duration and combinations thereof.

Furthermore, according to an embodiment of the present invention the receiving step includes organizing the data in a virtual master calendar.

Moreover, according to an embodiment of the present invention, the method further includes displaying the virtual master calendar on at least one display.

Additionally, according to an embodiment of the present invention, the adjusting step further includes organizing the data associated with each individual to form a daily individual total duration estimate.

Further, according to an embodiment of the present invention, the individual dynamic user-data based profile rankings are based daily on a comparison between daily individual total duration estimates of all individuals.

Furthermore, according to an embodiment of the present invention, the rankings are defined daily responsive to the comparison.

Moreover, according to an embodiment of the present invention, the profile rankings are ranked from busiest individual to freest individual to form an individuals' priority ranking.

Additionally, according to an embodiment of the present invention, the minimizing step includes minimizing a daily duration responsive to the individuals' priority ranking.

Furthermore, according to an embodiment of the present invention the outputting step includes uploading to a device associated with each user the future individualized event schedule.

Additionally, according to an embodiment of the present invention, the outputting step includes uploading at least one of a voicemail, a text message, an electronic mail, a visual display, an audio message and combinations thereof.

Moreover, according to an embodiment of the present invention, the method further includes providing each individual with dynamic content associated with each the event.

Additionally, according to an embodiment of the present invention the dynamic content includes: location data associated with the event; time data associated with the event;

duration data associated with the event; content data associated with the event; image data associated with the event; image data associated with other individuals attending the event; dynamic updates responsive to a dynamic location based (such as GPS-based) location of at least one other individual associated with the event; and combinations thereof.

Additionally, according to an embodiment of the present invention, the receiving step further includes receiving content from other databases, either using the same processor, or from a different processor and then dynamically merging contents into one unit, or flag as being connected to another content without merging.

Furthermore, according to an embodiment of the present invention, the outputting step further includes generating a personalized schedule including time, location and duration data associated with the individual user.

Additionally, according to an embodiment of the present invention, the outputting step further includes displaying at least some visual content associated with the events.

Moreover, according to an embodiment of the present invention, the dynamic content is interactive content.

Additionally, according to an embodiment of the present invention, the device is a portable communications device, selected from the group consisting of a smart phone, cellular phone, a Personal Computer (PC), a mobile phone, a mobile device, a computer, a speaker set, a television, a PDA and a tablet computer.

According to another embodiment of the present invention, the system of the present invention is configured to rank planned events in accordance with predefined criteria.

There is thus provided according to another embodiment of the present invention, a computer software product, the product configured for automatic event matching, the product including a computer-readable medium in which program instructions are stored, which instructions, when read by a computer, cause the computer to: receive time, location and duration data of planned events from a plurality of individual users and to store the data in a database; dynamically adjust the data associated with each user to define individual dynamic user-data based profile rankings; minimize total duration data responsive to the profile rankings; and output future individualized events schedules responsive to the minimizing step.

There is thus provided according to another embodiment of the present invention, a system for automatic event matching, the system including: a computer having a processor; a memory which is operably accessible to the processor; the software which operable on the processor, the software including event matching software, wherein the software is adapted to receive time, location and duration data of planned events from a plurality of individual users and to store the data in a database, dynamically adjust the data associated with each user to define individual dynamic user-data based profile ranking, minimize total duration data responsive to the profile rankings; and output future individualized events schedules responsive to the minimizing step.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail then is necessary for a fundamental understanding of the invention, the description taken with the drawings making apparent to those skilled in the art how the several forms of the invention may be embodied in practice.

In the drawings:

FIG. 1 is simplified pictorial illustration of a system for automatic or non-automatic appointment matching, in accordance with an embodiment of the present invention;

FIG. 2 is a simplified schematic of a method for automatic appointment matching, in accordance with an embodiment of the present invention;

FIG. 3 is a simplified flowchart of a method for non-automatic appointment matching, in accordance with an embodiment of the present invention;

FIG. 4A is a graphical output of planned meetings of a first user, in accordance with an embodiment of the present invention;

FIG. 4B is a table of planned events of the first user in accordance with an embodiment of the present invention;

FIG. 4C is a graphical output of planned meetings of a second user, in accordance with an embodiment of the present invention;

FIG. 4D is a table of planned events of the second user in accordance with an embodiment of the present invention;

FIG. 5A is an optimized updated table of planned events of the second user, in accordance with an embodiment of the present invention;

FIG. 5B is an optimized updated table of planned events of the first user in accordance with an embodiment of the present invention; and

FIG. 6 is a screen shot of user data input, in accordance with an embodiment of the present invention.

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

According to a preferred embodiment of the Invention, the method for electronically establishing a meeting between multiple parties, comprising the steps of: establishing electronic communications between the multiple parties; an initiating attendee scheduling a proposed meeting and identifying designated attendees and day, time and location of the proposed meeting; without active participation by the initiating attendee or the designated attendees automatically checking an electronic calendar for each designated attendee to determine if a designated attendee is available for the proposed meeting; and (1) if a designated attendee is available for the proposed meeting, without active participation by said initiating attendee or said designated attendees, changing a designation of the proposed meeting from proposed to confirmed with respect to the initiating attendee and the designated attendee, or (2) if a designated attendee is not available for the proposed meeting, without active participation by the initiating attendee or the designated attendees, changing a designation of the proposed meeting from “proposed” to “not available” with respect to the initiating attendee and the designated attendee.

The essence of this calendar method/system is that the meetings are arranged without any active participation by the attendees. While prior art methods may initiate such actions automatically, they all rely on some level of participation by the attendees. For example, though these prior art systems may automatically send an invitation to a person, that person must still take the affirmative action of responding. The system does not do it for him According to the herein calendar system, this step is also does automatically.

If desired, a designated attendees can invite additional invitees and the process is repeated for each of these additional invitees without active participation by the attendees. Thus, a designated attendee can invite a partner or an associate who is also involved in that project.

Another aspect of the herein calendar system/method is that it includes calculating travel time for an attendee to the location of the proposed meeting and determines if the attendee has sufficient travel time between other meetings to attend the proposed meeting. This too is an unique aspect of the herein method. By virtue of identifying the location of meetings, the system can in the background (without active participation of the invitee) calculate travel distance. Hence, for example, if a person has a prior meeting at 9:00 am until 10:00 am in Jerusalem, if he is invited to a meeting at 10:30 am on the same day in Tel Aviv, the system itself (without active participation of the invitee) can determine that there is not enough travel time between the meetings and automatically respond that the invited person is not available.

A further enhancement involves integration of this calendar system with GPS technology. On the day of the meeting without active participation by said attendees, the calendar system can continuously monitor a geographic location of an attendee; calculate travel time from a current geographic location of the attendee to the location of said meeting; determine if the attendee can get to the meeting on time; and, if the attendee cannot get to the meeting on time, without active participation by that attendee automatically electronically notifying other attendees that this attendee will be late. This means that other attendees can plan accordingly, and no one has to stand around doing nothing while waiting for someone to show up. In other words, for example, if an attendees gets the automatic notice that another attendee will be 30 minutes late, he can adjust his schedule and leave a little later so he does not have to wait too long. This monitoring of a geographic location of an attendee can be accomplished with a GPS device/chip/module in a mobile communication device of that attendee.

By virtue of the GPS device, without active participation by that attendee, the calendar system can automatically select an optimum route to the meeting for said attendee. It may also mention how to travel—foot, car, bus, taxi, trains, etc.

Another aspect of the calendar system is the initiating attendee can identify the subject matter of a meeting and then, without active participation by the initiating attendee or the designated attendees, the location of the meeting is automatically determined based on the subject matter of said meeting. For example, a sales meeting would automatically be at the buyer's location.

Further, the calendar system can without active participation by the initiating attendee or the designated attendees prioritize meetings based on the subject matter. In advance each user can select a personal prioritizing protocol. For example, sales meetings may have priority over marketing meetings.

Another aspect is automatically finding an open time slot for a meeting. If a designated attendee is not available for the proposed meeting, without active participation by the initiating attendee or the designated attendees, the herein calendar system searches electronic calendars of the initiating attendee and the designated attendees to identify an open time slot for the proposed meeting. This means evaluating day, time and location of each meeting to identify a compatible time slot for all attendees for the proposed meeting.

If desired, the calendar method may include a manual override feature so a designated attendee can elect to not attend the proposed meeting.

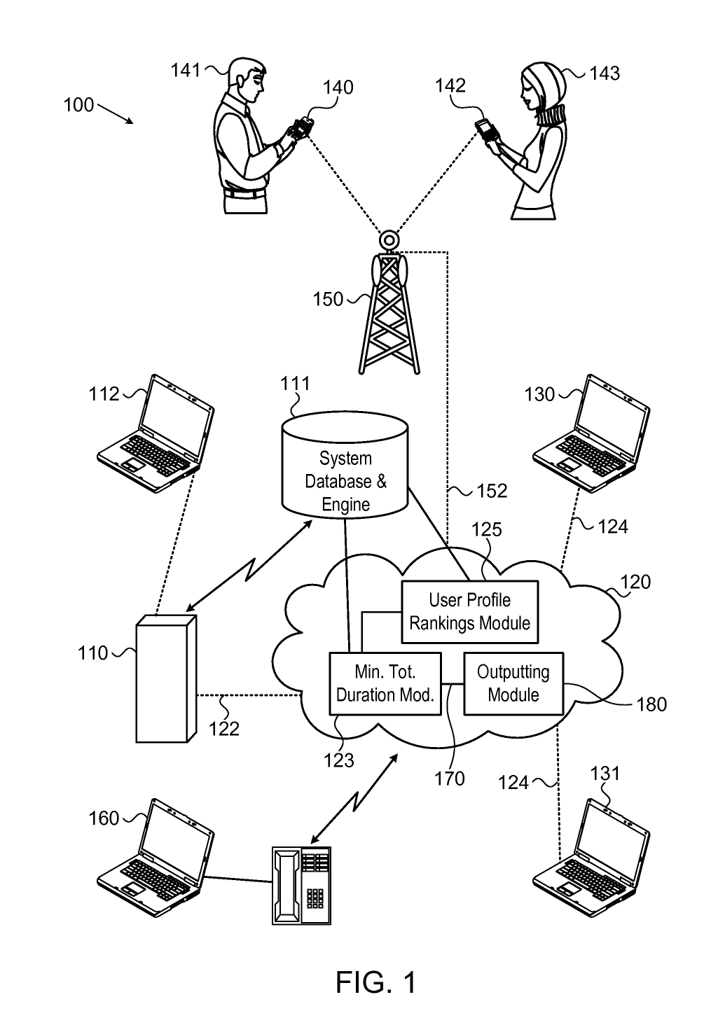

Reference is now made to FIG. 1, which is a simplified pictorial illustration showing a system 100 for automatic or non-automatic appointment matching, in accordance with an embodiment of the present invention.

System 100 typically includes a server utility 110, which may include one or a plurality of servers and one or more control computer terminals 112 for programming, trouble-shooting servicing and other functions. Server utility 110, includes a system engine and database, 111, a user profile ranking module 125; a minimizing total duration module, 123, and an outputting module 127, which are linked to the Internet 120 (constituting a computer network) through link 122, for running matching application 123 for user-data based automatic or non-automatic appointment matching in the system.

Together, user-generated meetings are generated. Both users 141, 143 may communicate with server 110 through a plurality of user computers 130, 131, or user devices 140, 142, which may be mainframe computers with terminals that permit individual to access a network, personal computers, portable computers, small hand-held computers and other, that are linked to the Internet 120 through a plurality of links 124. The Internet link of each of computers 130, 131, may be direct through a landline or a wireless line, or may be indirect, for example through an intranet that is linked through an appropriate server to the Internet. System 100 may also operate through communication protocols between computers over the Internet which technique is known to a person versed in the art and will not be elaborated herein. Users may also communicate with the system through portable communication devices such as 3rd generation mobile phones 140, communicating with the Internet through a corresponding communication system (e.g. cellular system) 150 connectable to the Internet through link 152. As will readily be appreciated, this is a very simplified description, although the details should be clear to the artisan. Also, it should be noted that the invention is not limited to the user-associated communication devices—computers and portable and mobile communication devices—and a variety of others such as an interactive television system may also be used. The system 100 also typically includes at least one call and/or user support center 160. The service center typically provides both on-line and off-line services to users. The server system 110 is configured according to the invention to carry out the above-described method for automatic or non-automatic appointment matching. Meeting matching is performed by modules 123, 125, 127, through an API (Application Programming Interface), 170. Some of the screen shots of the website appear hereinbelow.

It should be understood that many variations to system 100 are envisaged, and this embodiment should not be construed as limiting. For example, a facsimile system or a phone device (wired telephone or mobile phone) may be designed to be connectable to a computer network (e.g. the Internet). Interactive televisions may be used for inputting and receiving data from the Internet.

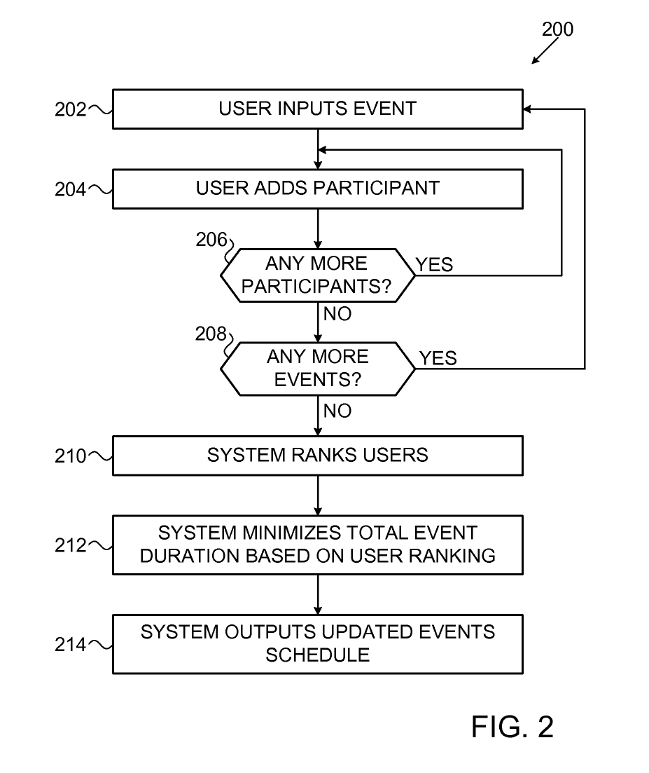

Reference is now made to FIG. 2, which is a simplified schematic of a method 200 for automatic appointment matching, in accordance with an embodiment of the present invention.

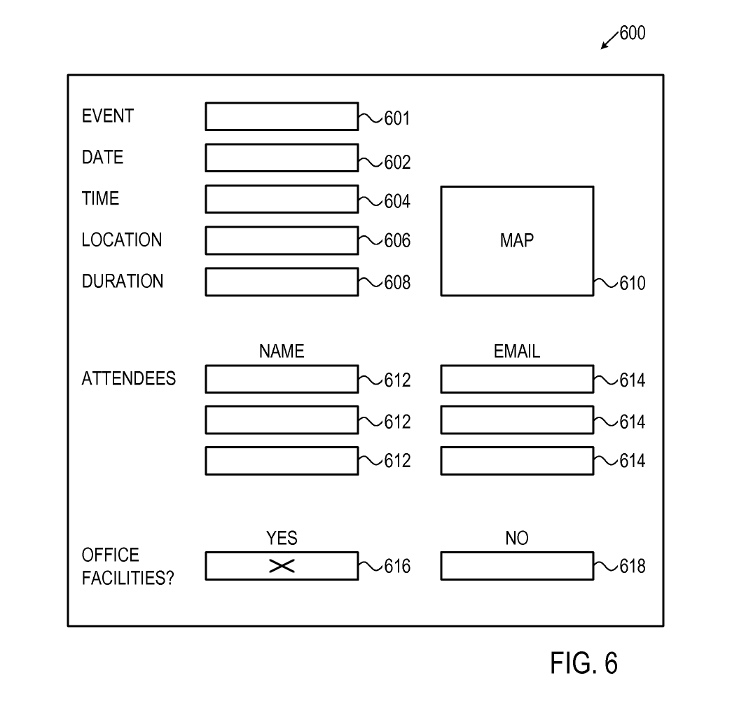

In a first user-inputting step 202, a user, such as user 141 (FIG. 1) inputs an event into an on-screen calendar application (see FIG. 6 for details).

Turning to FIG. 6, there is a screen shot 600 of user data input, in accordance with an embodiment of the present invention. The user may be provided with pull-down menus or may be able to type in alpha-numeric data into a number of slots 602, 604,606, 608, 610, 612, 614, 616 and 618. For example, for each event 601, a name is given to the event. The user can then input a date 602, a time 604, location 606 and duration of the event 608. Additionally, the user can use a location-based (such as GPS-based) map system 610 to locate location 606. Typically, the user then defines a number of attendees by their name and email, for example in a participant addition step 204. Additionally, he may add further user data, such as cellphone numbers, office telephone numbers, Skype addresses and the like. Some events require office facilities and others do not. The user typically enters this as a yes 616/no 618 data entry.

System 100, in addition to checking availability of all participants, is constructed and configured to adjust conference calls and/or video calls according to the time zones such that they are matched and synchronized. The system determines time zones, and adjusts the output to the participants accordingly.

The system also provides a participant with an option to override the automatic setting and not have specific events or meetings moved by setting a set date and start time. Thus, the start time and date cannot be moved by other participants.

Additionally or alternatively, the system can be configured to send updates to all event participants so that all the participants pre-approve every change in their personal schedule.

Additionally, when a user adds a conference or any other event to his calendar, the system is operative to forward invitations to other participants, such as a partner or a friend. The system is then operative to set a place and time where it is easiest for both/all to meet for a pre-conference meeting, prior to the conference and then all participants can go to the conference together,

Turning back to FIG. 2, system 100 may prompt user 141 for more information to check if all the information for the event has been inputted. For example, the system may ask the user if all the participants have been added in a checking step 306 and thereafter if all the events user 141 plans for a certain day have been added in an event checking step 208.

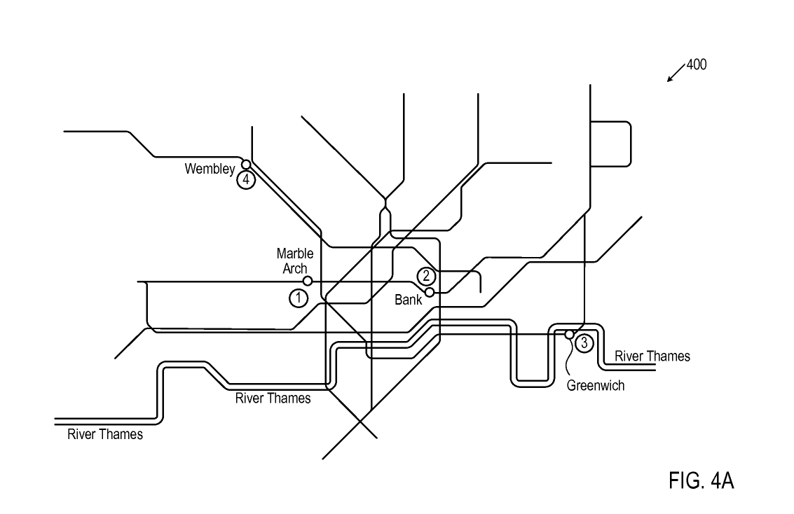

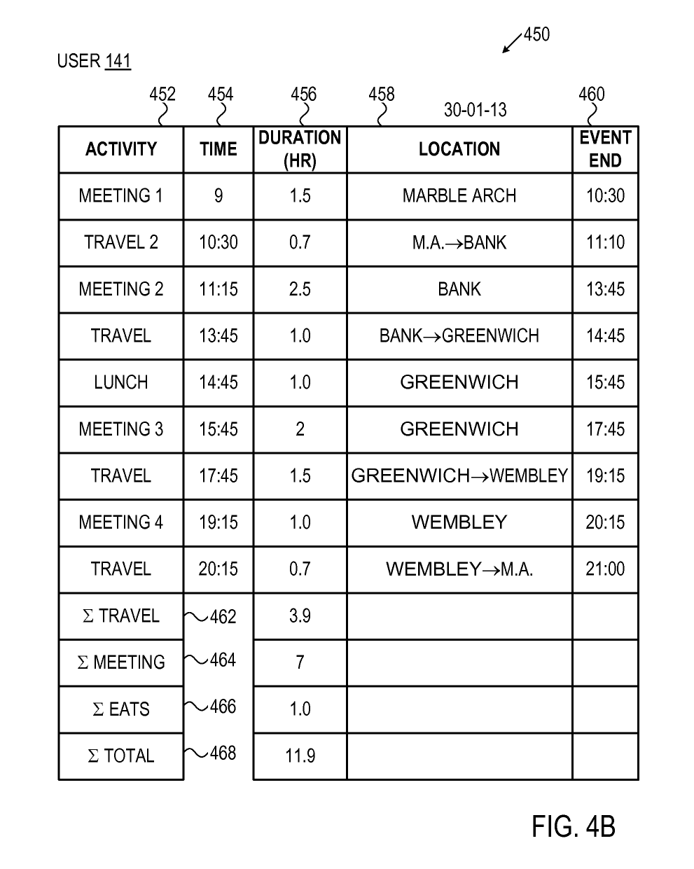

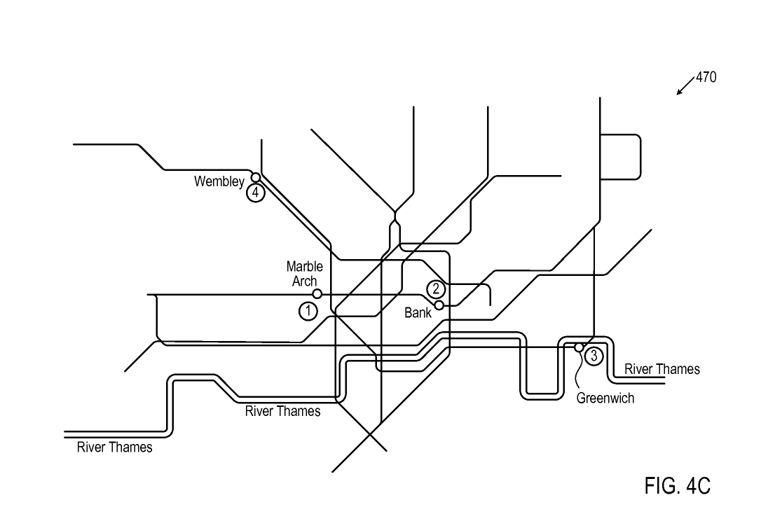

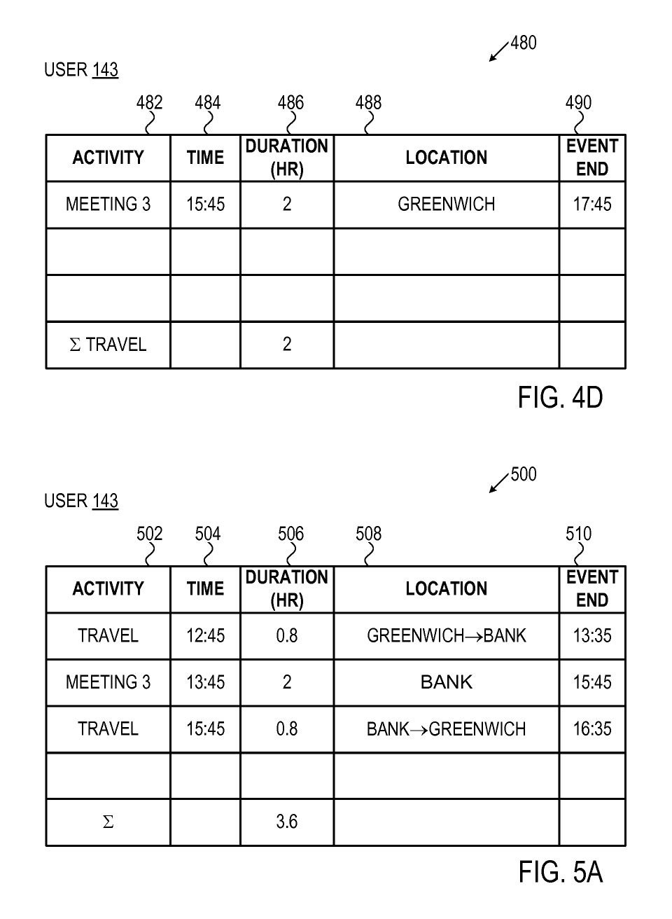

Once all the users have been entered by user 141 or independently by other users, the system is operative to rank the users according to their schedule on that particular day and/or by their history in database 111. An example of ranking of two participants is described in further detail hereinbelow with respect to FIGS. 4A-4D. Additionally or alternatively, the ranking may be performed according to other criteria, such as position in a company, turnover, income, fame, other criteria or combinations thereof.

The user ranking may be generated by algorithms in the user-profile ranking module 125 (FIG. 1) and may be stored in database 111.

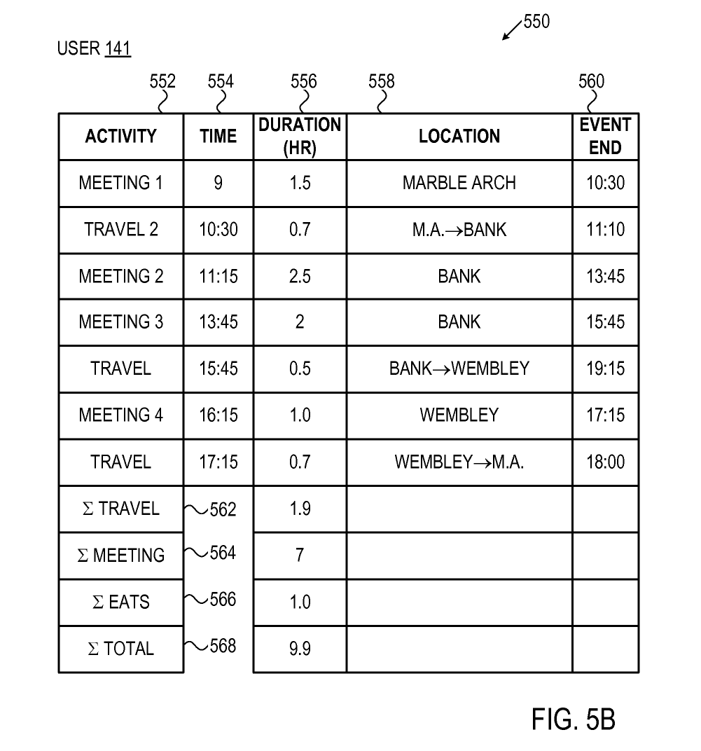

System 100 (FIG. 1) is then operative to minimize the total event duration in a minimizing step 212, for that particular day and the users/participants (see FIGS. 4A-5B, for example). The algorithms used to minimize the total events' durations may be or include any suitable algorithm in the art and may include any one or more of: critical pathway algorithms (see Kelley Jr, James E., and Morgan R. Walker. “Critical-path planning and scheduling.” Papers presented at the Dec. 1-3, 1959, eastern joint IRE-AIEE-ACM computer conference. ACM, 1959., Siemens, Nicolai. “A simple CPM time-cost tradeoff algorithm ” Management Science 17.6 (1971): B-354. incorporated herein by reference); scheduling delay (Arnott, Richard, Andre De Palma, and Robin Lindsey. Schedule delay and departure time decisions with heterogeneous commuters. No. 1197. 1988. incorporated herein by reference); and/or, software to minimize travel time (Waze—Lequerica, Ivan, Miguel Garcia Longaron, and Pedro M. Ruiz. “Drive and share: efficient provisioning of social networks in vehicular scenarios.” Communications Magazine, IEEE 48.11 (2010): 90-97). incorporated herein by reference)

Step 212 may be performed in whole or in part by the minimizing module 123 (FIG. 1).

An updated output, if required, is sent by system 100 to all the events' participants in an outputting step 214. See FIGS. 5A-5B for example.

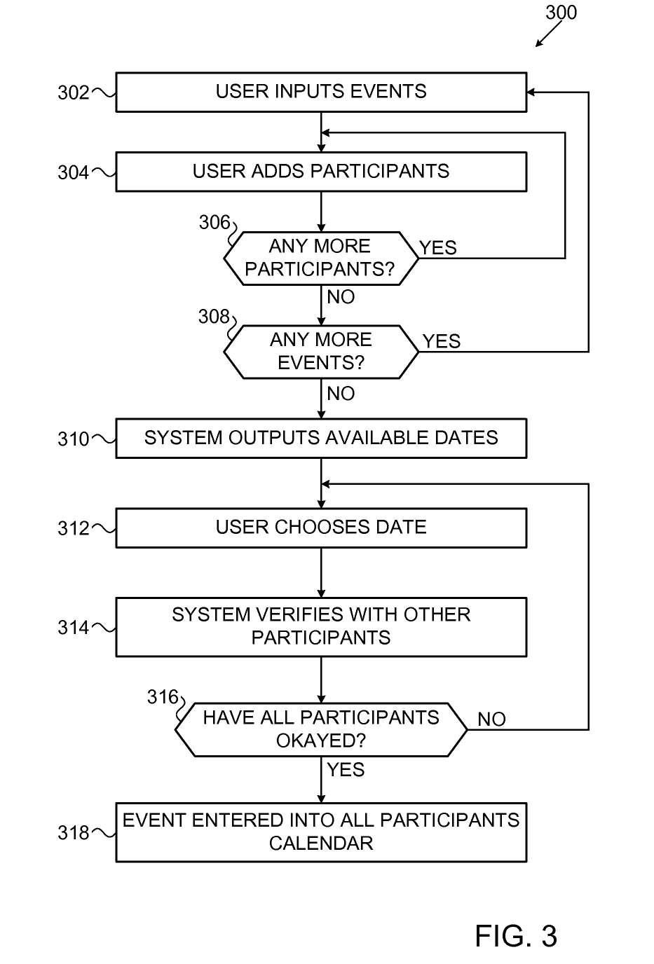

Reference is now made to FIG. 3, which is a simplified flowchart 300 of a method for non-automatic appointment matching, in accordance with an embodiment of the present invention.

All events are inputted by users in at least one user inputting step 302 into server utility 110 for self-matching in a data entry step 302, via mobile phones 140, 142 and/or user computers 130, 131. The events may be stored in a memory of the server utility 110 or at remote memories in the cloud.

Additional participants may be added in a participant addition step 304. Typically, the user then defines a number of attendees by their name and email, for example in a participant addition step 304. Additionally, he may add further user data, such as cellphone numbers, office telephone numbers, Skype addresses and the like.

System 100 may prompt user 141 for more information to check if all the information for the event has been inputted. For example, the system may ask the user if all the participants have been added in a checking step 306 and thereafter if all the events user 141 plans for a certain day have been added in an event checking step 308.

System 100/is operative to automatically schedule a first event by finding the earliest available time free to all participants using a predefined methodology in a scheduling step 310.

Additionally or alternatively step 310 may be replaced by a manual scheduling step (not shown). This means that system 100 shows each user only dates that are available to all participants (using a predefined methodology).

In a choosing step 312, the user chooses a first preferred schedule for the event. The first user never sees the other participants' schedules.

System 100 then verifies the date for the event with the other participants in a verification step 314. Each user only sees the available dates and times in his calendar for this event, when all invited participants are confirmed to be available.

In a checking step 316, the system checks if all users have confirmed the available date. If no, a new date and time may be sent to all the participants, and steps 312-316 repeated.

If yes, then the event is entered into all the calendars of all the participants in an event entry step 318.

Each participant, when receiving the event invitation has the following options: accept/add participants/decline (and if accept/add participants follow to step “B”); reply to the originator and add the new participants and follow the choice of A & B of Step 1, and so one for all recipients.

Reference is now made to FIG. 4A, which is a graphical output 500 of planned meetings of a first user, in accordance with an embodiment of the present invention. Output 500 may be a map, a schematic, a table or any other suitable output for mapping the planned events of a user for a particular day. In this case, user 141 has four events at four different locations in London. The output provided shows the events with their locations mapped on the London Underground map.

Duration module 123 (FIG. 1) is operative to estimate the total travel time from locations 1 to 2, 2 to 3, 3 to 4 and 4 back to 1.

Reference is now made to FIG. 4B, which is a table of planned events 450 of the first user 141 in accordance with an embodiment of the present invention. Duration module outputs a preliminary schedule to the first user 141 on his device 140, for example. The table comprises a list of activities/events 452, a time to commence each event 454, a duration 456 of each event, a location 458 of each event and an event end time 460.

As can be seen from table 450, user 141 will spend around 3.9 hours on travel, 7 hours in four meetings and one hour for lunch, totaling 11.9 hours.

Reference is now made to FIG. 4C, which is a graphical output 470 of planned meetings of a second user 143 (FIG. 1), in accordance with an embodiment of the present invention. User 143 only needs to attend meeting 3 with user 141. This meeting is currently planned for Greenwich. User 143's schedule is shown in FIG. 4D, which is a table 480 of planned events of the second user in accordance with an embodiment of the present invention.

The table comprises a list of activities/events 482, a time to commence each event 484, a duration 486 of each event, a location 488 of each event and an event end time 490.

The total time of user 143's activities is two hours. The total time of both users 141 and 143's activities are 11.9+2 hours=13.9 hours.

System 100 may also be operative to perform any one or more of the following functions.: send a short message (SMS) to a user/participant to notify of a delay of the next event or events; update about delays in transport or traffic; update a location of a next event or events due to changes in transport or traffic; choose a new location for an event due to an updated event requirement—such as needing office facilities, an overhead projector or the like; Enable a manual override of an event location, duration or participant; Location based (such as, but not limited to, GPS (global positioning system)) updates to users to assist them finding a location; Update a user in real-time of anticipated travel time for himself/other participant to reach location (the true location of the other participant will not be relayed, due to privacy); update that another participant is not in the required vicinity; Update that another participant is already in the required vicinity; Update a user in real-time when to leave and to take real-time traffic conditions/time required for journey into account so that he/she can reach the next event in good time; Update all participants automatically/manually in real-time of any delays by any participant to reach the event location (only delays); and/or Update all participants in real-time (automatically or manually) when a participant has reached the event location, or when the conference call has started.

Reference is now made to FIG. 5A, which is an optimized updated table 500 of planned events of the second user in accordance with an embodiment of the present invention.

The table comprises a list of activities/events 502, a time to commence each event 504, a duration 506 of each event, a location 508 of each event and an event end time 510. Now, the event 3 has been moved from Greenwich to Bank and an additional 1.6 hours of travel time has been added to user's 143 itinerary.

Reference is now made to FIG. 5B, which is an optimized updated table 550 of planned events of the first user in accordance with an embodiment of the present invention. Two hours of travel time have been removed from the itinerary of the first user, reducing his day from 11.9 to 9.9 hours.

The total time of both users 141 and 143's activities are 9.9+3.6 hours=13.5 hours. Thus time of the busiest user 141 is reduced by 2 hours and time of the least busy user 143 is increased by 1.6 hours, thereby saving 0.4 hours all round.

System 100 further provides a user with an option to automatically set his device 140 on silent or any other profile, and/or sending your phone to voicemail, when the user is busy at an event.

System 100 further provides a user with an option to have a sign or a message at the contact to see if he is available before calling him (for example: if he is on the phone, in a meeting, conference, lunch, etc.).

The system also enables a user to perform any one or more of the following on his device: To update other participants that he/she is unavailable to attend an event, answer a phone call, attend a conference, lunch, vacation, out of reach, our of country, out of office (and might also be linked to the calendar); To display at his/her contact page an alternate contact, for example if on vacation or longer time leave; To provide a timeline when will he/she will become available; and/or To schedule a phone call with one or more other participants, about user's next availability, and the system is operative to connect between the user and other participants automatically and to connect them.

The present invention employs software for an electronic calendar. The calendaring software is software that minimally provides users with an electronic version of a calendar. Additionally, the software may provide an appointment book, address book, and/or contact list. These tools are an extension of many of the features provided by time management software such as desk accessory packages and computer office automation systems. Calendaring is a standard feature of many PDAs, EDAs, and smartphones, such as devices 140, 142, 112 and 130 (FIG. 1).

The software may be a local package designed for individual use (e.g. Lightning extension for Mozilla Thunderbird, Microsoft Outlook without Exchange Server, or Windows Calendar) or may be a networked package that allows for the sharing of information between users (e.g. Mozilla Sunbird, Windows Live Calendar, Google Calendar, or Microsoft Outlook with Exchange Server).

The present invention is described herein with reference to flow chart illustrations and/or block diagrams of methods, apparatus (systems) and computer program products according to embodiments of the invention. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow charts and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flow charts and/or block diagram block or blocks.

Although the embodiments described above mainly address assessing test coverage of software code that subsequently executes on a suitable processor, the methods and systems described herein can also be used for assessing test coverage of firmware code. The firmware code may be written in any suitable language, such as in C. In the context of the present patent application and in the claims, such code is also regarded as a sort of software code.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A method for automatic event matching, the method comprising:
a. receiving time, location and duration data of planned events from a plurality of individual users and to store the data in a database;
b. dynamically adjusting said data associated with each user to define individual dynamic user-data based profile rankings;
c. minimizing total duration data responsive to said profile rankings; and
d. outputting future individualized events schedules responsive to said minimizing step.

2. A method for automatic appointment matching according to claim 1, wherein said duration data comprises, event duration, travel to event duration, travel from event duration, waiting time duration, communications duration and combinations thereof.

3. A method for automatic appointment matching according to claim 1, wherein said receiving step comprises organizing said data in a virtual master calendar.

4. A method for automatic appointment matching according to claim 3, further comprising displaying said virtual master calendar on at least one display.

5. A method for automatic appointment matching according to claim 1, wherein said adjusting step further comprises organizing said data associated with each individual to form a daily individual total duration estimate.

6. A method for automatic appointment matching according to claim 5, wherein said individual dynamic user-data based profile rankings are based daily on a comparison between daily individual total duration estimates of all individuals.

7. A method for automatic appointment matching according to claim 6, wherein said rankings are defined daily responsive to said comparison.

8. A method for automatic appointment matching according to claim 7, wherein said profile rankings are ranked from busiest individual to freest individual to form a individuals' priority ranking.

9. A method for automatic appointment matching according to claim 8, wherein said minimizing step comprises minimizing a daily duration responsive to said individuals' priority ranking.

10. A method for automatic appointment matching according to claim 1, wherein said outputting step comprises uploading to a device associated with each user said future individualized event schedule.

11. A method for automatic appointment matching according to claim 10, wherein said outputting step comprises uploading at least one of a voicemail, a text message, an electronic mail, a visual display, an audio message and combinations thereof.

12. A method for automatic appointment matching according to claim 10, further comprising providing each individual with dynamic content associated with each said event.

13. A method for automatic appointment matching according to claim 12, wherein said dynamic content comprises location data associated with said event;
a. time data associated with said event;
b. duration data associated with said event;
c. content data associated with said event;
d. image data associated with said event;
e. image data associated with other individuals attending said event;
f. dynamic updates responsive to a dynamic location based or GPS-based location of at least one other individual associated with said event; and
g. combinations thereof.

14. A method according to claim 1, wherein said receiving step further comprises receiving content from other databases, either using the same processor, or from a different processor and then dynamically merge contents into one unit, or flag as being connected to another content without merging.

15. A method according to claim 1, wherein said outputting step further comprises generating a personalized schedule including time, location and duration data associated with said individual user.

16. A method according to claim 15, wherein said outputting step further comprises displaying at least some visual content associated with said events.

17. A method according to claim 13, wherein said dynamic content is interactive content.

18. A method according to claim 10, wherein said device is a portable communications device is selected from the group consisting of a cellular phone, a Personal Computer (PC), a mobile phone, a mobile device, a computer, a speaker set, a television and a tablet computer.

19. A method according to claim 1, further comprising ranking said planned events according to predefined criteria.

20. A computer software product, said product configured for automatic event matching, the product comprising a computer-readable medium in which program instructions are stored, which instructions, when read by a computer, cause the computer to:
a. receive time, location and duration data of planned events from a plurality of individual users and to store the data in a database;
b. dynamically adjust said data associated with each user to define individual dynamic user-data based profile rankings;
c. minimize total duration data responsive to said profile rankings; and
d. output future individualized events schedules responsive to said minimizing step.

21. A system for automatic event matching, the system comprising:
a. a computer having a processor;
b. a memory which is operably accessible to the processor;
c. the software which operable on the processor, the software including event matching software, wherein the software is adapted to:
i. receive time, location and duration data of planned events from a plurality of individual users and to store the data in a database;
ii. dynamically adjust said data associated with each user to define individual dynamic user-data based profile rankings;
iii. minimize total duration data responsive to said profile rankings; and
iv. output future individualized events schedules responsive to said minimizing step.

22. A method for electronically establishing a meeting between multiple parties, comprising the steps of:
a. establishing electronic communications between said multiple parties;
b. an initiating attendee scheduling a proposed meeting and identifying designated attendees and day, time and location of said proposed meeting;
c. without active participation by said initiating attendee or said designated attendees automatically checking an electronic calendar for each designated attendee to determine if a designated attendee is available for said proposed meeting; and
d. 1. If a designated attendee is available for said proposed meeting, without active participation by said initiating attendee or said designated attendees, changing a designation of said proposed meeting from proposed to confirmed with respect to said initiating attendee and said designated attendee; or,
2. If a designated attendee is not available for said proposed meeting, without active participation by said initiating attendee or said designated attendees, changing a designation of said proposed meeting from proposed to not available with respect to said initiating attendee and said designated attendee.

23. A method according to claim 22, wherein said automatically checking includes calculating travel time for an attendee to said location of said proposed meeting and determining if said attendee has sufficient travel time between other meetings to attend said proposed meeting.

24. A method according to claim 23, further comprising on said day of said meeting without active participation by said attendees;
a. continuously monitoring a geographic location of an attendee;
b. calculating travel time from a current geographic location of said attendee to said location of said meeting;
c. determining if said attendee can get to said meeting on time; and
d. if said attendee cannot get to said meeting on time, without active participation by said attendee automatically electronically notifying other attendees that said attendee will be late.

25. A method according to claim 24, wherein said continuously monitoring a geographic location of an attendee includes using a GPS device in a mobile communication device of said attendee.

26. A method according to claim 24, further comprising without active participation by said attendee selection of an optimum route to said meeting for said attendee.

27. A method according to claim 22, wherein said initiating attendee identifies subject matter of said meeting and then without active participation by said initiating attendee or said designated attendees said location is automatically determined based on said subject matter of said meeting.

28. A method according to claim 27, further comprising without active participation by said initiating attendee or said designated attendees prioritizing meetings based on said subject matter.

29. A method according to claim 22, further comprising, if a designated attendee is not available for said proposed meeting, without active participation by said initiating attendee or said designated attendees, searching electronic calendars of said initiating attendee and said designated attendees to identify an open time slot for said proposed meeting.

30. A method according to claim 29, wherein said searching electronic calendars includes evaluating day, time and location of each meeting to identify a compatible time slot for all attendees for said proposed meeting.

31. A method according to claim 22, further comprising said designated attendees inviting additional invitees and steps c and d being repeated for each of said additional invitees without active participation by said attendees.

32. A method according to claim 22, further comprising a manual override feature so a designated attendee can elect to not attend said proposed meeting.
